(19) United States
(12) Patent Application Publication
(10) Pub. No.: US 2015/0352804 A1
(43) Pub. Date: Dec. 10, 2015

(54) CEMENTITIOUS COMPOSITE

(71) Applicants: Milliken & Company, Spartanburg, SC (US); Concrete Canvas Technology Ltd, Pontypridd (GB)

(72) Inventors: Randolph S. Kohlman, Boiling Springs, SC (US); David E. Wenstrup, Greer, SC (US); Pradipkumar Bahukudumbi, Greenville, SC (US); Peter Brewin, Cheshire (GB); William Crawford, Cardiff (GB); Marcin Kujawski, 6 Pontypridd (GB)

(21) Appl. No.: 14/298,070

(22) Filed: Jun. 6, 2014

(51) Int. Cl. B32B 5/02; B32B 3/26; B32B 3/28; B32B 27/12; B32B 27/32; B32B 7/08; B32B 3/30; B32B 5/26

(52) U.S. Cl. CPC B32B 5/022; B32B 3/30; B32B 3/26; B32B 5/26; B32B 27/12; B32B 27/32; B32B 7/08; B32B 3/28; B32B 2250/03; B32B 2250/24; B32B 2260/023; B32B 2260/044; B32B 2262/0284; B32B 2264/102; B32B 2307/546; B32B 2607/00; B32B 2571/02; B32B 2597/00; B32B 2439/00

(57) ABSTRACT

An improved, composite textile that can become rigid or semi-rigid by e.g., applying a liquid is provided. The composite can include a high loft non-woven layer having a first face and a second face and a midpoint between the first face and the second face. The high loft non-woven layer includes bulking fibers crossing the midpoint plane that form a tangential line at the midpoint plane that is at non-zero angle as set forth herein.

### FIELD OF THE INVENTION

The subject matter of the present disclosure relates generally to an improved, composite textile that can become rigid or semi-rigid by e.g., applying a liquid.

### BACKGROUND

A flexible textile or cloth that can be positioned into a desired shape or configuration and then caused to harden or rigidify upon e.g., the application of a liquid (such as water) or radiation has numerous applications and benefits. For example, the textile can be positioned to form a structure and then hardened to provide a protective hard armor barrier. Similarly, the textile can be deployed to form e.g., a temporary roadway, temporary wall, erosion barrier, waste containment structure, temporary or permanent form work, structural liner for piping, ditching or culverts, a slope protection and stabilization layer and numerous other applications. Multiple sheets of such textile may be used together depending upon e.g., the size of the application.

As such, depending upon the intended application, it is desirable to be able to provide such a textile that can be readily manufactured in various customized sizes and thicknesses. The ability to provide such a textile having improved mechanical properties such as e.g., improved strength is also desirable.

The textile may be deployed e.g., in emergency situations or otherwise dangerous environments or in construction projects where a rapid installation is advantageous. For example, the textile may installed and used in a combat zone or in an area where a natural disaster has occurred. In such situations, minimizing the exposure of personnel during installation and/or utilizing the hardened textile as quickly as possible may be paramount. Thus, a textile having a capability to be rapidly installed and set is highly desirable.

### BRIEF SUMMARY

In one exemplary embodiment, the present invention provides a flexible cementitious composite capable of becoming rigid or semi-rigid. The exemplary composite includes a high loft non-woven layer having a first face and a second face with the second face separated from the first face by a space. The high loft non-woven layer includes bulking fibers and a binding material, wherein at least a portion of the bulking fibers are connected to other bulking fibers within the high loft non-woven layer through the binding material. A midpoint between the first face and the second face of the high loft non-woven layer defines a midpoint plane, wherein at least about 50% by number of bulking fibers crossing the midpoint plane form a tangential line at the midpoint plane of between about 45 degrees and 90 degrees.

This exemplary composite also includes a settable powder located in the high loft non-woven layer, wherein the settable powder is capable of setting to a rigid or semi-rigid solid on the addition of a liquid. A filter layer is located on the first face of the high loft non-woven layer, wherein the filter layer includes projections which project at least partially into the high loft non-woven layer. The filter layer includes pores that are sufficiently small so as to retain at least a portion of the settable powder within the high loft non-woven layer but allow the passage of the liquid. A liquid barrier layer is positioned on the second face of the high loft non-woven layer, wherein the liquid barrier layer has a coefficient of water permeability of less than about 1×10⁻⁸ m/s.

In another exemplary embodiment, the present invention provides a rigid or semi-rigid cementitious composite that includes a high loft non-woven layer having a first face and a second face with the second face separated from the first face by a space. The high loft non-woven layer includes bulking fibers and a binding material, wherein at least a portion of the bulking fibers are connected to other bulking fibers within the high loft non-woven layer through the binding material. A midpoint between the first face and the second face of the high loft non-woven layer defines a midpoint plane, wherein at least about 50% by number of bulking fibers crossing the midpoint plane form a tangential line at the midpoint plane of between about 45 degrees and 90 degrees.

This exemplary embodiment includes a cured rigid or semi-rigid solid located in the high loft non-woven. A filter layer is located on the first face of the high loft non-woven layer, wherein the filter layer includes projections which project at least partially into the high loft non-woven layer, and wherein the filter layer comprises pores that are sufficiently small as to retain at least a portion of the settable powder within the high loft non-woven layer but allow the passage of the liquid. A liquid barrier layer is positioned on the second face of the high loft non-woven layer, wherein the liquid barrier layer has a coefficient of water permeability of less than about 1×10⁻⁸ m/s.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

FIG. 1 is cross-sectional illustrative view of one exemplary embodiment of a flexible cementitious composite.

FIG. 2 is cross-sectional illustrative view of one exemplary embodiment of a high loft non-woven layer.

FIG. 3 illustrates the angle of a bulking fibers relative to the midpoint plane.

FIG. 4 is cross-sectional illustrative view of another exemplary embodiment of a flexible cementitious composite.

FIGS. 5A, 5B, 5C, 5D, and 5E illustrate the process of compressing under heat and pressure a filled high loft non-woven layer.

FIG. 6A is cross-sectional illustrative view of one exemplary embodiment of the filter layer having projections.

FIG. 6B is cross-sectional illustrative view of one exemplary embodiment of the composite having a filter layer with projections.

FIGS. 7-8 illustrate puckers in a filter layer in a composite.

### DETAILED DESCRIPTION

For purposes of describing the invention, reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

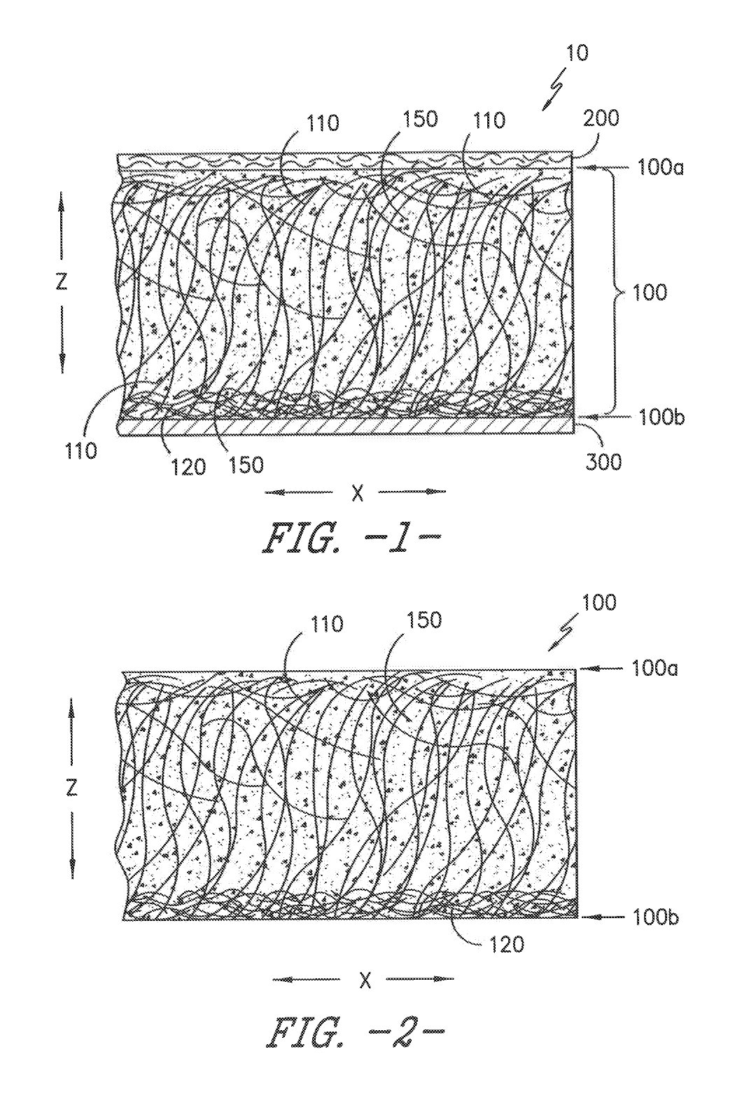

FIG. 1 illustrates a first exemplary embodiment of a flexible cementitious composite 10 of the present invention that is capable of becoming rigid or semi-rigid. The flexible cementitious composite 10 contains a high loft non-woven layer 100, settable powder 150 located in the high loft non-woven layer 100, a filter layer 200, and a liquid barrier layer 300. In general, the high loft non-woven layer 100 serves to provide a three-dimensional matrix with volume that can be filled with the settable powder 150. The filter layer 200 resists the movement of the settable powder out of the flexible composite, but allows a fluid to enter and interact with the settable powder to cause it to become rigid or semi-rigid. The liquid barrier layer 300 resists movement of fluids into or out of the composite at the face to which it is attached.

As shown in FIG. 2, the high loft non-woven layer 100 contains a first face 100a and a second face 100b separated from the first face 100a by a space. The high loft non-woven layer 100 contains bulking fibers 110 and a binding material 120.

The binding material 120 may be any suitable material that is able to connect the bulking fibers 110 to other bulking fibers 110. For example, the binding material 120 may be made of a material that forms a thermal bond upon melting and cooling. Preferably, the binding material 120 has a lower melting temperature than the bulking fibers (in the embodiments where the bulking fibers have a melting temperature). In one embodiment, the binding material 120 may be in the form of binding fibers. These binding fibers are able to melt at lower temperatures (as compared to the bulking fibers 110) and may be, for example, low melt fibers, bi-component fibers, such as side-by-side or core and sheath fibers with a lower sheath melting temperature, and the like. In one exemplary embodiment, the low melt fibers are a polyester core and sheath fiber with a lower melt temperature sheath. In one embodiment, the bulking fibers 110 have an average denier greater than the average denier of the binding fibers.

In one embodiment, the binder fibers are in an amount of greater than about 60% wt (weight percent) of the non-woven layer 100. In another embodiment, the binder fibers are in an amount of greater than about 50% wt of the non-woven layer 100. In another embodiment, the binder fibers are in an amount of greater than about 40% wt of the non-woven layer 100. Preferably, the binder fibers have a denier less than or about equal to 15 denier.

In another embodiment, the binding material 120 is an adhesive powder. This adhesive powder may be placed inside the high loft non-woven layer 100 as the layer 100 is formed, or after it is formed. In this embodiment, the adhesion between the bulking fibers 110 results from a thermal bond which is set by a subsequent heated process that melts the adhesive powder. In another embodiment, the binding material 120 may be a spray adhesive. The spray adhesive may be applied to the bulking fibers 110 before formation into a high loft non-woven layer 100 or to the high loft non-woven layer 100 after it is formed. In this embodiment, the adhesion between the bulking fibers is set by drying, subsequent heat treatment, UV treatment, or the like of the sprayed adhesive.

The bulking fibers 110 may be any suitable fiber. Types of bulking fibers would include fibers with high denier per filament (5 denier per filament or larger, more preferably 25 denier or larger, more preferably 100 denier or larger), high crimp fibers, hollow-fill fibers, and the like. These fibers provide mass and volume to the material, Some examples of bulking fibers 110 include polyester, polyethylene terephthalate, polypropylene, and cotton, as well as other low cost fibers. Preferably, the bulking fibers have a denier greater than about 12 denier. In another embodiment, the bulking fibers 110 have a denier greater than about 15 denier. The bulking fibers are preferably staple fibers. In one embodiment, the bulking fibers 110 are bonded together through the binding material 120 such that there is a continuous linkage of bulking fibers 110 between the first face 100a and the second face 100b.

Preferably, the bulking fibers 110 are self-supporting and should be sufficiently stiff, i.e. they should be sufficiently resistant to bending under forces tending to crush the textile body, so as to maintain the spacing between faces 100a and 100b when settable powder 150 is loaded into the high loft non-woven layer 100. When it is said that the bulking fibers 110 are self-supporting, this includes embodiments where the bulking fibers individually are not self-supporting, but the collection of bulking fibers 110 is self-supporting. The density of the bulking fibers 110, i.e. the number of fibers (or yarns) per unit area, is also an important factor in resisting crushing forces while the settable powder 150 is added, in maintaining the spacing between faces 100a and 100b, and in restricting the movement of the particles forming powder material 150 once they are trapped between first face 100a and second face 100b. It is preferable that the bulking fibers 110 do not divide the space within the high loft non-woven layer 100 into individual small closed compartments. Such a division may potentially restrict the settable powder from hardening into a unitary mass. In turn, this could allow cracks to form and propagate within the high loft non-woven layer 100, reducing its strength once the settable powder 150 has set to a rigid or semi-rigid solid between first face 100a and second face 100b.

A variety of different materials may be used for the bulking fibers 110. In one exemplary embodiment, bulking fibers 110 are a monofilament yarn as this provides the greatest stiffness for textile body 105. In one embodiment, bulking fibers 110 are hydrophilic to allow wicking of water during hydration of the settable powder. It is also desirable that bulking fibers 110 are chemically resistant to powder material 150. Suitable fibers for use as bulking fibers 110 forming the high loft non-woven layer 100 include polypropylene fibers, which have excellent chemical resistance to alkaline conditions present when settable powder 150 is a cement; coated glass fibers, which can provide reinforcement to the powder material; polyethylene fibers; polyvinylchloride (PVC) fibers, which have the advantage of being relatively easy to bond using chemical or thermal bonding; polyethylene terephthalate (PET) fibers, polyvinyl alcohol (PVA) fibers, carbon fibers, basalt fibers and others.

In addition to the bulking fibers 110 and the binding fibers 120, the high loft non-woven layer 100 may contain additional fibers such as a second binder fiber having a different denier, staple length, composition, or melting point, a second bulking fiber having a different denier, staple length, or composition, and a fire resistant or fire retardant fiber. The additional fiber may also be an effect fiber, providing a desired aesthetic or functional benefit. These effect fibers may be used to impart color, chemical resistance (such as polyphenylene sulfide fibers and polytetrafluoroethylene fibers), moisture resistance (such as polytetrafluoroethylene fibers and topically treated polymer fibers), heat resistance, creep resistance, stiffness or tensile strength such as AR glass fibers or basalt fibers or others.

The fibers (bulking fibers 110, binding fibers 120, and/or additional fibers) may additionally contain additives. Suitable additives include, but are not limited to, fillers, stabilizers, plasticizers, tackifiers, flow control agents, cure rate retarders, adhesion promoters (for example, silanes and titanates), adjuvants, impact modifiers, expandable microspheres, thermally conductive particles, electrically conductive particles, silica, glass, clay, talc, pigments, colorants, glass beads or bubbles, antioxidants, optical brighteners, antimicrobial agents, surfactants, fire retardants, and fluoropolymers. One or more of the above-described additives may be used to reduce the weight and/or cost of the resulting fiber and layer, adjust viscosity, or modify the thermal properties of the fiber or confer a range of physical properties derived from the physical property activity of the additive including electrical, optical, density related, liquid barrier or adhesive tack related properties. The fibers may also contain a preferred sizing on the fiber surface to preferentially bond to the settable powder during hydration.

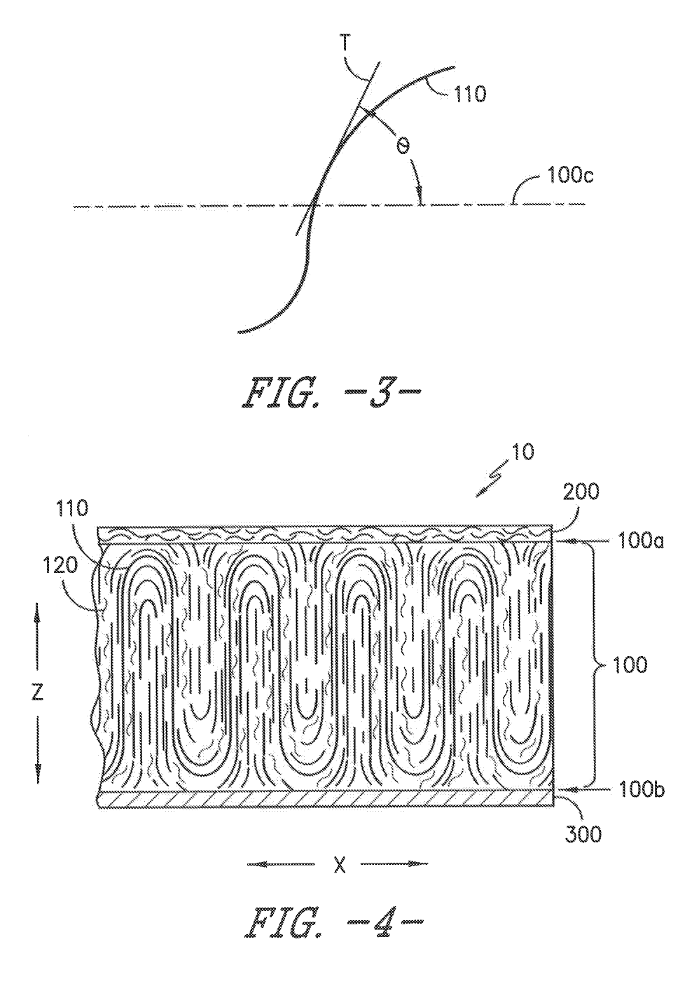

As shown in FIG. 3, the midpoint between the first face 100a and the second face 100b of the high loft non-woven layer 100 defines a midpoint plane 100c. In some embodiments, the bulking fibers 110 are preferentially oriented in the z-direction at this midpoint plane 100c, which helps the loft and compression resistance of the high loft non-woven layer 100 and improves the drape properties of the filled composite textile. Angle θ is shown in FIG. 3 where a bulking fiber 110 is illustrated crossing the midpoint plane 100c. At the point where the bulking fibers 110 crosses the plane 110, a tangent line T is drawn. The angle from the tangent line T to the plane 100c is shown as angle θ.

This high loft non-woven layer 100 having a high z-axis orientation of the bulking fibers 110 at the midpoint plane 100c may be formed in any suitable manner.

In one embodiment, the high loft non-woven layer 100 is stratified meaning that there is a concentration gradient of one or more of the components in the high loft non-woven layer 100. Such stratified non-woven is still integral in that the high loft non-woven layer 100 is created at one time as one unitary layer, not as separate layers with different concentrations that are then combined (such as using needling, adhesives, etc).

In one embodiment, one or both of the surface 100a and/or 100b of the high loft non-woven layer 100 may contain a higher concentration of the binding material 120. This binding material 120 (in one embodiment being low melt binding fibers) may be sufficiently melted and consolidated to reduce the surface's permeability to powder so that it can act as a filter layer on its own. This melted and consolidated surface is sometimes referred to in the art as a “skin” layer. This skin layer may be sufficient unto its own that no additional separate filter layer may have to be attached to the high loft non-woven layer 100. This integrally formed filter layer 200 may be advantaged in some applications as the filter layer is created at the same time as the high loft non-woven layer 100 thus reducing processing steps and possibility increasing the bonding between the two layers 100, 200. A stratified high loft non-woven layer is shown by way of example in FIG. 2, where the concentration of e.g., bulking fibers 110 increases near second face 100b. In one embodiment, the composite 10 may contain both an integral filter layer 200 formed by skinning one surface of the high loft non-woven layer 100 and an additional filter layer 200 attached to the integral filter layer. In this embodiment, the additional filter layer 200 may be attached to the high loft non-woven layer 100 through the binding material located at the surface of the high loft non-woven layer 100.

In one exemplary embodiment, the high loft non-woven layer 100 is formed using a K-12 HIGH LOFT RANDOM CARD by Fehrer AG (Linz, Austria). In the K-12 process, the varying concentration of the fibers in the non-woven is accomplished by using fibers types having different deniers, which results in the different fibers collecting on a collection belt primarily at different locations. The fibers are projected along the collection belt in the same direction as the travel direction of the collection belt. Fibers with a larger denier will tend to travel further than smaller denier fibers down the collection belt before they fall to the collection belt. As such, there will tend to be a greater concentration of the smaller denier fibers closer to the collection belt than larger denier fibers. Also, there will tend to be a greater concentration of the larger denier fibers farther from the collection belt than smaller denier fibers. This process, in one embodiment, contains a vacuum at the collection belt. This process, in addition to creating a stratification also creates a z-axis orientation in the bulking fibers. The z-axis (shown as Z in the Figures) forms a z direction, also referred to as the vertical direction. This is beneficial because it increases the stiffness and strength of the high loft non-woven layer 100 in the z direction and also decreases the stiffness in the mid-plane directions, both of which reduces the propensity for puckers to form when the material is curved.

In another embodiment shown in FIG. 4, the flexible composite 10 contains a high loft non-woven layer 100, which is a vertically lapped material constructed in such a way that a continuous folding of the material (bulking fibers 110 and binding material 120) creates a lapped, corrugated, or pleated structure. The resultant high loft non-woven layer 100 has pleats which are very close together such that a continuous non-woven layer is formed. One effective way to achieve the maximum amount of resilience, compression resistance, and recovery is with a vertical fiber orientation (“vertical fiber orientation” or “vertically oriented” means that the fiber is aligned with the z-axis). In this embodiment, the high loft non-woven comprises serpentine-like arrangement of a multiplicity of pleats in which adjoining pleats physically contact each other thereby causing the structure to be a self-supporting structure, and wherein the pleats are generally parallel to adjacent pleats. In this application, “self-supporting structure” is defined to be that the structure created by the plurality of fibers or yarns is able to withstand the processing conditions without being irreversibly crushed.

In one embodiment, the high loft non-woven layer 100 is formed using a Struto™, vertical lapper technology, which takes a non-woven and folds or pleats it to produce a vertically folded product of given thickness. This process is preferred for some products as the lapping creates a high degree of z-axis orientation of the bulking fibers at the midpoint plane of the high loft non-woven layer 100.

The Struto machine creates vertically lapped fiber orientation as opposed to a horizontally laid fiber orientation. The purpose of using the Struto system is to make the most resilient structure possible with the least amount of fiber when compared to other structures. As in any non-woven process, the fibers must be opened prior to blending. Once properly blended the fibers are carded. The carded web is conveyed up an incline apron and is fed into the Struto lapping device. The vertical lapper then folds the web into a uniform structure. The folds may be compressed together into a continuous lapped structure and may be thermally bonded and cooled causing the thermally bonded structure to become more permanent. The pleated structure with vertically oriented staple fibers maximizes stiffness of the high loft non-woven layer 100 in Z-direction. In addition, the pleated structure allows for preferential elongation/stretch in one direction which can be beneficial in some installations.

In one embodiment, the bulking fibers 110 (individually or collectively) are curved into a C shape at the first face 100a and the second face 100b, whereat the lapped structure meets the faces 100a and 100b and curves back towards the other face (making an approximate 180 degree turn). The resultant formation of bulking fibers 110 on the first face 100a and second face 100b enables better interaction and attachment to additional layers (such as the liquid barrier layer 300 and filter layer 200).

Measurement of the fiber angle relative to this midpoint plane were obtained in both the initial unfilled nonwoven article and in the settable-powder filled flexible composite (both before and after exposure of the flexible composite to a liquid to rigidify it). In all cases, specimens which represent the various embodiments were prepared and a center plane was marked midway between the top and bottom face of the material. Using microscopic techniques, a digital image of the specimen for which the fiber angles were being measured was taken. The image was taken as a side profile of the specimen so that the midpoint plane could be clearly identified, with sufficient focus and depth of field, that multiple fibers could be identified; and their angle at the midpoint plane could be determined using either digital analysis or by printing out the image and using a protractor (or equivalent) to determine the angle of each fiber. A fiber crossing the midpoint plane at a right angle (oriented perpendicular to the midpoint plane) was given an angular measurement of 90 degrees; and likewise a fiber running parallel to the center plane was given an angular measurement of zero. At least 45 fibers were measured in a side profile that represents a sample length of about 10 mm to define a histogram of the angular distribution of fibers at the midpoint plane. The histogram of the midpoint plane fiber angles was generated with a specific frequency count taken of fibers with angles of 0-10, 11-20, 21-30, 31-40, 41-50, 51-60, 61-70, 71-80, 81-90. Fibers that were substantially out of the cut plain were not counted to prevent a distortion of the result due to foreshortening.

In one embodiment, at least about 60% by number of the total number of the bulking fibers within the high loft non-woven (before introducing the settable powder) that cross the midpoint plane form a tangential line T at the midpoint plane 100c having an angle θ of between about 60 and 90 degrees. In another embodiment, at least about 70% of the bulking fibers that cross the midpoint plane form a tangential line T at the midpoint plane 100c of between about 70 and 90 degrees. In another embodiment, at least about 80% of the bulking fibers that cross the midpoint plane form a tangential line T at the midpoint plane 100c of between about 70 and 90 degrees. In another embodiment, at least about 90% of the bulking fibers that cross the midpoint plane form a tangential line T at the midpoint plane 100c of between about 75 and 90 degrees.

Referring back to FIG. 1, there is shown a settable powder 150 in the high loft non-woven layer 100 that is located in the space between first face 100a and second face 100b and resides in the spaces or voids within the high loft non-woven layer 100. The settable powder 150 is capable of setting so that high loft non-woven layer become rigid or semi-rigid body between first face 100a and second face 100b. The settable powder 150 may be settable on the addition of a liquid such as e.g., water, and in one embodiment may comprise cement, optionally together with sand or fine aggregates and/or plasticizers and other additives found in cement or concrete compositions that will set to solid cement or concrete on the addition of water or a water-based solution. The settable powder 150 and/or the liquid combined therewith can include additives, e.g., setting catalysts, accelerants, retarders, waterproofing agents, pH modifiers, recycled filler materials, glass beads, pozzolanic materials such as fly ash, pigments and other colorants, micro capsules containing bacteria, clays, foaming agents, fillers, light-weight materials such as foam beads, reinforcement materials, reinforcing fillers and fibers, anti-microbial additives etc., that are known in the art in connection with the settable powder.

The settable powder 150 may be introduced into the high loft non-woven layer 100 in any suitable manner. In one embodiment, the settable powder 150 is mixed with the fibers 110, 120 during the formation of the high loft non-woven layer 100. In another embodiment, the settable powder 150 is introduced into the high loft non-woven layer 100 after the high loft non-woven layer 100 is formed.

In this embodiment, the settable powder 150 is introduced into the non-woven layer through pores on one of the faces 100a, 100b. The settable powder 150 that is placed on the high loft non-woven layer 100 will fall through the three-dimensional tortuous porous network and fill the pore volume with settable powder 150, when suitable forces are applied. The penetration through the pores can be assisted by placing the high loft non-woven layer 100 on a vibrated or mechanically tapped (periodically struck or dropped) bed and by brushing the fill into the pores using a static or rotating brush, optionally assisted by a vacuum slot, or the like. The settable powder 150 may be introduced in metered doses along the length of the table to avoid forming an overburden of settable powder 150 at any one location along the machine, which can lead to excessive compression of the high loft non-woven layer 100 from the weight of the powder 150, or unacceptable powder flow due to cohesive forces in the overburden. Vibration also has the advantage of dispersing and packing the settable powder 150 in the three-dimensional space to the required density, while and minimizing the formation of voids or air-pockets. In one embodiment, the non-woven layer is mechanically elongated by an applied force while the powder is being introduced. When the applied force is reduced, the recovery of the fabric helps to further pack the powder. This packing effect can be further augmented by heating the substrate to cause the substrate to shrink and pack the powder. In one embodiment, the settable powder 150 is added through the second face of the high loft non-woven layer, which already has a filter layer 200 attached to the first face 100a of the high loft non-woven layer 100. After filling, an additional layer such as a liquid barrier layer 300 may be added to the second face 100b of the high loft non-woven layer 100.

In one embodiment, the settable powder 150 is added to the high loft non-woven layer 100 in an amount less than would completely fill the void space between the fibers in the high loft non-woven layer 100. By controlling the amount of settable powder 150 added, the mass per unit area of the composite 10 may be controlled.

In one embodiment, the partially filled high loft non-woven layer 100 may be compressed under heat and pressure and then cooled under pressure to decrease the thickness of the high loft non-woven layer 100 (thickness being the distance between the first face 100a and the second face 100b) and to increase the density of the resultant compressed high loft non-woven layer 100. When the filled high loft non-woven layer is compressed, the void space within the high loft non-woven layer 100 is reduced and the added heat activates the adhesive material 120 (for the first time or reactivates it) as well; optionally softening the bulking fibers 110 if the temperature rises above the fibers' 110 respective softening point. When the filled layer 100 is cooled still under pressure, the thickness and density of the filled high loft non-woven layer are set at a lower thickness and higher density. This embodiment may be advantageous for some applications to more easily create a filled high loft non-woven layer 100 with a specific thickness and density. In addition to using compression to increase the packing density of a high loft non-woven layer, this compression may be used for other settable powder filled structures such as spacer fabrics, foams, and geostructures.

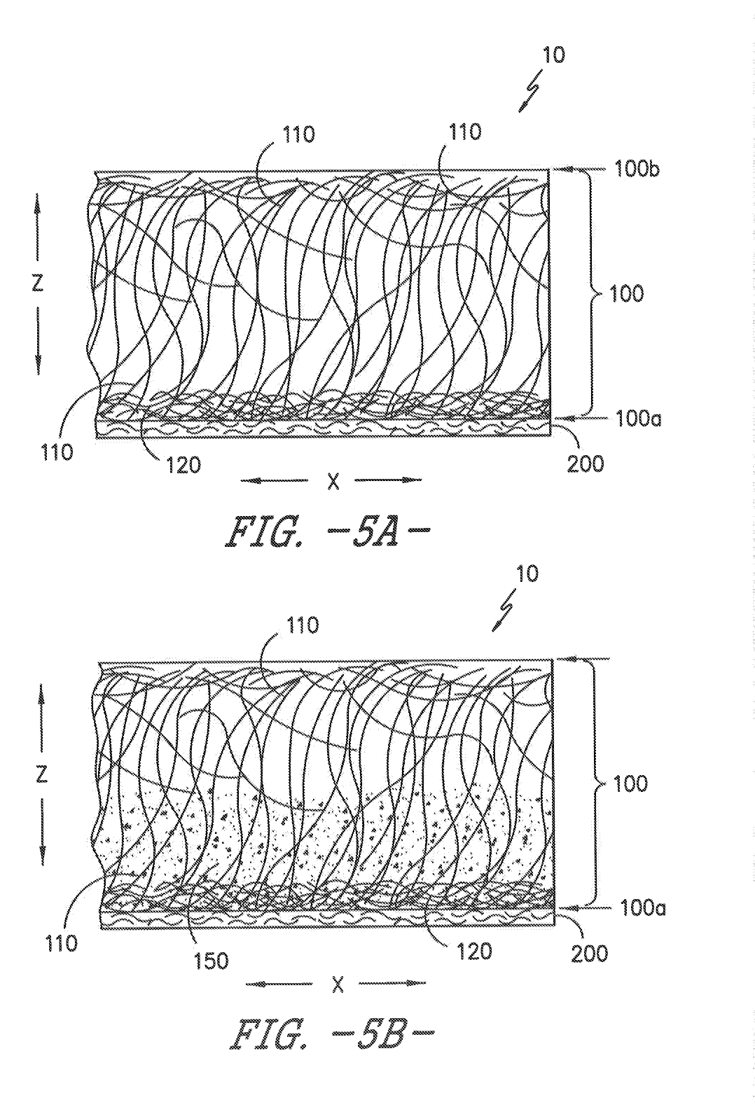

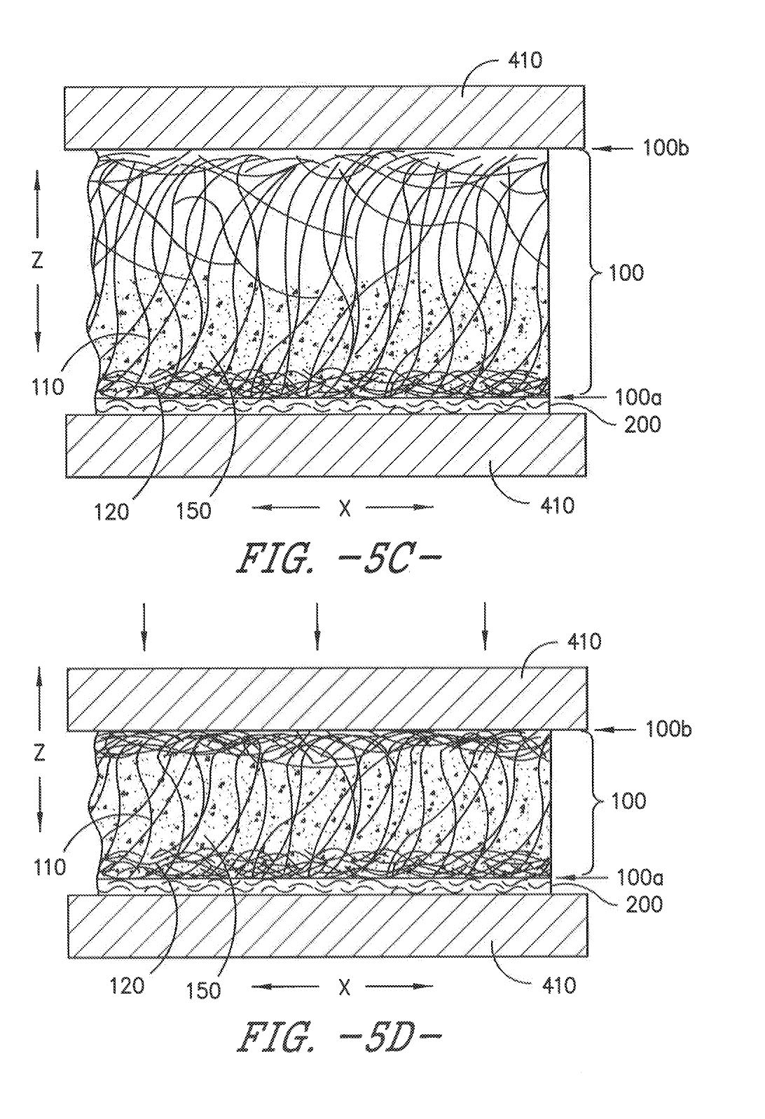

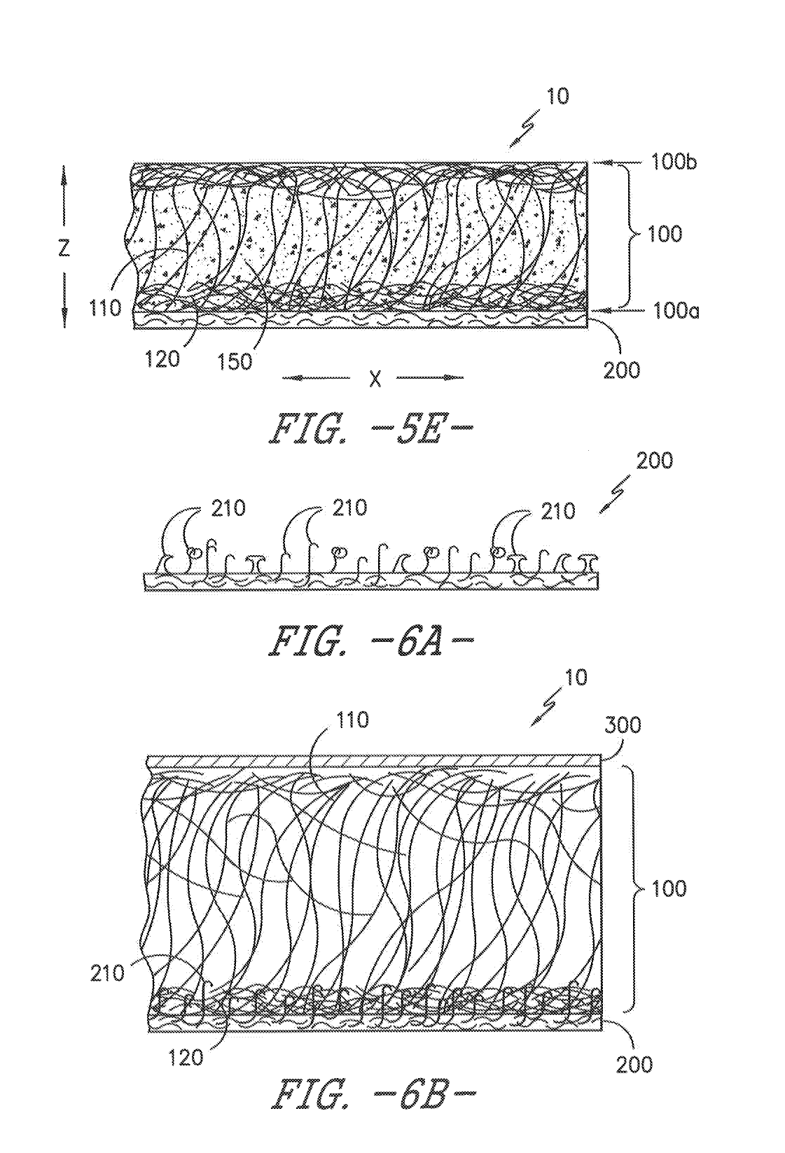

FIGS. 5A, 5B, 5C, 5D, and 5E illustrate an exemplary compression process. FIG. 5A illustrates a high loft non-woven layer 100 unfilled (meaning that it does not yet contain any settable powder). The filter layer 200 is optionally on the first face 100a of the high loft high loft non-woven layer 100. FIG. 5B shows the high loft non-woven layer 100 partially filled with settable powder 150. The settable powder 150 does not fill all of the void space within the high loft non-woven layer 100.

The resulting “filled product” (which could be at the exit of a vibration table) has a higher density of settable powder 150 near the first face 100a of the non-woven. In addition, a significant portion of the available pore volume in the high loft non-woven layer 100, typically closer to the second face 100b, can remain unfilled with settable powder 150.

In one embodiment, after the settable powder 150 impregnation step (FIG. 5B), a liquid barrier layer 300 is introduced over the second face 100b of the high loft non-woven layer 100 before heated presses 410 are introduced on the top and bottom surface (FIG. 5C). In FIG. 5D, the heated presses 410 compress the filled high loft non-woven layer (100 and 150).

These heated presses 410 may be continuous, such as in heated belts or rollers, or combinations thereof, or may be discrete as in a heated platen. In one example, the heated presses may be a double belt laminator (e.g. Schott & Meissner ThermoFix). In an alternative embodiment, the heated presses 410 may be a hydraulic platen press, which is used to consolidate the composite 10 to the desired density. The functional principle of a flatbed laminator is a combination of contact heat and pressure. The composite 10 to be processed is passed through the machine by being held in between two teflon-coated or steel conveyor belts. Heat transfer may be by means of heating plates, which are positioned right beneath the top and bottom conveyor belts. Additionally, the composite 10 can be passed through one or multiple pairs of nip-rolls, arranged in-line one after the other, as an integrated part of the flatbed laminator, with the product still being held in between the conveyor belts while being compressed by the calibrated rollers. The laminator is used to set the final product density by compressing the product to the desired thickness and to bond the optional liquid barrier layer 300 to the high loft non-woven layer 100.

The temperature of the belts is usually greater than the melting point of the binder material 120 in the high loft non-woven layer 100. The pressure in the nip rolls is set to achieve the final product density. The settable powder 150 provides significant resistance to further compression after a certain threshold density is reached. The contact heat applied to the composite 10 allows the binder material 120 to soften/melt facilitating product compression.

The compressed filled high loft non-woven layer is then preferably cooled while still under pressure. FIG. 5E illustrates the resultant flexible cementitious composite 10 having a higher density and a lower thickness as compared to before compression. This exemplary compression process has the advantage of fixing the thickness and density of the high loft non-woven layer, By accurately controlling the density it is possible to achieve a material with improved mechanical properties when set. In particular, the density affects the strength, permeability, durability and hardness of the set composite textile.

In the embodiment where the heated presses 410 are a laminator, subsequent to the heating zone, the flatbed laminator incorporates a cooling area. This zone is for cooling the product down and to “freeze” the achieved product features by means of cooling plates, which are also positioned right beneath the top and bottom conveyor belts. A separate, independent lifting unit which is connected to the cooling plates allows for cooling and/or to calibrate the thickness of the composite 10 either with or without pressure.

This compression process has the advantage of determining, at the time of manufacture, the thickness and density of the high loft non-woven layer 100 and the composite 10. The packing density greatly affects the strength, permeability, durability and hardness of the composite 10.

In one embodiment, the density of filled high loft non-woven layer (high loft non-woven layer 100 and settable powder 150) is at about 1.2 g/cm³, more preferably at least about 1.4 g/cm³. This density range, given the typical density of the non-woven fibers and the settable powder, restricts the volume of the non-woven layer, where the settable powder is principally contained, to be sufficiently filled with settable powder that only a controlled amount of water can fill the remaining space. This has the effect of keeping the water to dry product weight ratio less than about 45%, and more preferably less than about 35%. By restricting the water amount that can be absorbed by the product, the strength of the cured settable powder is maintained in a desirable range. In another embodiment, the ratio of fiber (all fibers within the high loft non-woven layer 100) to the settable powder 150 is between about 1:100 to 3:50 by weight. By keeping the fiber to settable powder weight ratio in these ranges, there is sufficient fiber to provide the mechanical strength required by the filled-non-woven layer during handling and installation of the product before hydration and curing, while also keeping the volume of non-woven reasonably easy to fill with powder during the manufacturing process. The relatively large open volume for settable powder allows for dense packing of the settable powder and higher strength for the cured product.

It will be appreciated by one skilled in the art that the measured density of the current invention is dependent upon the thickness measured for the textile composite. Thickness is typically measured with a comparator that has a base and an indicator. The thickness measurement is based on the difference in height between the base and the indicator. Different comparators exert a different downward pressure on the sample. For compressible materials such as the current invention, the measured thickness depends upon the downward force and the surface area of contact. For the density ranges recorded here, a comparator was used that exerts a downward force of 40 grams force over a circular contact area with diameter of 2 inches.

After manufacturing the flexible composite 10, the angle of the fibers in the high loft non-woven layer 100 may be modified somewhat from the initial angles of the input high loft non-woven by the forces involved in the process.

For the flexible composite before exposure to a rigidifying liquid, the fiber angle distribution was measured on a specimen prepared using a specific process. The specimen was cut from the unset flexible composite with a rotary fabric cutter; then, the settable powder was removed from the cut edge using a vacuum. A digital photograph was taken using a microscope at a magnification of 20× as described previously. A histogram of the fiber angles was generated as described previously.

With regards to measurement of the fibers in the final rigid or semi-rigid article, increased sampling was required to obtain enough samples to build a midpoint-plane fiber-angle histogram since the rigid or semi-rigid powder material can obscure the fiber direction (and make measurement of fiber angle impossible by this technique), unless the specimen is cut on its side profile at an angle that a sufficient length of the fiber is clearly visible. Enough specimens with different side-profile angular cuts were prepared and measurements were made such that a histogram could be pieced together.

Analysis of the fiber orientation in the cross-section of the manufactured flexible composite shows that in one embodiment, at least about 50% of the bulking fibers that cross the midpoint plane form a tangential line T at the midpoint plane 100c of between about 45 and 90 degrees. In another embodiment of the flexible composite, at least about 50% of the bulking fibers that cross the midpoint plane form a tangential line T at the midpoint plane 100c of between about 50 and 90 degrees. In a further embodiment of the composite, at least about 80% of the bulking fibers that cross the midpoint plane form a tangential line T at the midpoint plane 100c of between about 55 and 90 degrees. It will be appreciated that these fiber angles can be measured by removing the settable powder from the composite (e.g., with a vacuum) and using the microscopic analysis techniques described above to measure these angles.

The filter layer 200 shown in FIG. 1 may be any suitable filter layer and may be part of the high loft non-woven layer 100 or a separate layer attached to the high loft non-woven layer 100 on the first face 100a of the high loft non-woven layer 100. The filter layer serves to allow liquid to pass through the filter layer 200 to the settable powder 150 within the high loft non-woven layer 100 while keeping most or all of the settable powder 150 within the cementitious composite 10. In some embodiments, the filter layer 200 contains pores which are preferably sufficiently small to prevent the settable powder 150 from falling through the filter layer 200 but will allow liquid to pass through. In one embodiment, the filter layer comprises hydrophilic fibers and is water permeable to allow hydration of the product. In one embodiment, the filter layer 200 is a woven, non-woven, knit, spunlace, spunbond, spunbond-meltblown-spunbond composite, perforated film or combinations of the above.

In the embodiments where the filter layer 200 is integral to the high loft non-woven layer 100, the first face 100a of the high loft non-woven layer 100 is defined to be the place within the high loft non-woven layer 100 where the composite 10 transitions from the high loft non-woven layer 100 to the filter layer 200. In one embodiment, the binder material from the high loft non-woven layer on the first face 100a is subjected to heat to sufficiently melt and fuse the binder material on the face 100a to create a filter layer 200. In one embodiment, where the high loft non-woven layer 100 is stratified, there may be a higher concentration of adhesive material 120 on the first face 100a of the high loft non-woven layer 100, which can be fused to form a filter layer. In another embodiment, additional adhesive material is added onto the first face 100a of the high loft non-woven layer 100, which is then subjected to heat (and optionally pressure) to melt the adhesive material and form a filter layer.

In another embodiment, the filter layer 200 is attached to the first face 100a of the high loft non-woven layer 100 and is not integral to the high loft non-woven layer 100. The filter layer 200 may be attached to the high loft non-woven layer 100 by any suitable means such as adhesive materials including binder fibers from the high loft non-woven layer 100, additional binder fibers, spray adhesive, UV curable adhesive, mechanical interlocking (for example needle punching, quilting, stitch bonding, entangling, and hydro entangling), and/or projections.

The filter layer 200 may be added to the high loft non-woven layer 100 in any step of the formation of the cementitious composite 10. In one embodiment, the filter layer 200 is attached to a previously formed high loft non-woven layer 100. The filter layer may be attached before or after the optional heat and pressure compression. In an alternative embodiment, the high loft non-woven layer 100 may be formed on a filter layer 200.

In one embodiment, the filter layer 200 contains projections that extend from the surface of the filter layer 200 and into at least a portion of the thickness of the high loft non-woven layer 100 through the first face 100a. The projections mechanically lock the filter layer 200 with the fibers within the high loft non-woven layer 100 and/or the settable powder 200, especially after the settable powder has cured. In one embodiment these projections are formed by needling the filter layer 200 to the high loft non-woven layer to drag fibers from both layers into the other layer and mechanically entangle these fibers.

In a preferred embodiment, the projections are formed by needling the filter layer 200 to the high loft non-woven layer. The process of needling drags fibers from the filter layer through the high loft non-woven layer 100, thereby mechanically orienting and interlocking the fibers of both layers together. This mechanical interlocking is achieved with thousands of barbed felting needles repeatedly passing into and out of the web. In another preferred embodiment, a hot melt gravure lamination process can also be used to attach the filter layer 200 to the high loft non-woven layer 100.

In one embodiment, the projections 200 project into the high loft non-woven layer 100 at least about 0.4 mm, so that the projection from the filter layer extends sufficiently beyond the interface with the high loft non-woven layer that it may come into contact with settable powder, and become embedded in rigid set powder material in use, and resist delamination of the filter layer. In another embodiment, the projections 200 project into the high loft non-woven layer 100 at least about 0.7 mm, more preferably at least about 1.0 mm. In another embodiment, the projections 200 project into the high loft non-woven layer 100 between about 0.4 mm and 5 mm. In one embodiment, the projections 200 project into the high loft non-woven layer 100 at least about 5% of the thickness of the high loft non-woven layer 100 (defined to be the distance between the first face 100a and the second face 100b). In another embodiment, the projections 200 project into the high loft non-woven layer 100 at least about 10% of the thickness of the high loft non-woven layer 100, more preferably at least about 15%. In another embodiment, the projections 200 project into the high loft non-woven layer 100 between about 5% and 50% of the thickness of the high loft non-woven layer 100.

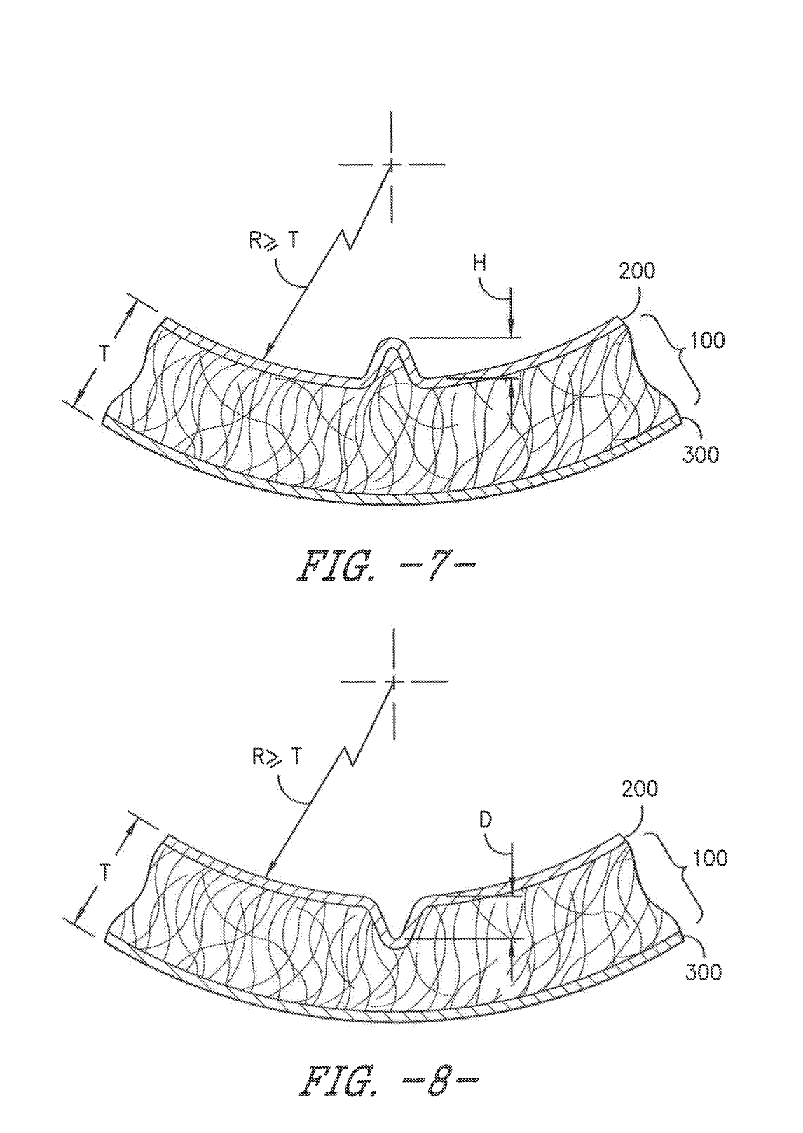

In one embodiment shown in FIG. 6A, some varying designed projections shown as reference number 210 have a hook shape and attach to the high loft non-woven layer 100 like a hook and loop (VELCRO™) attachment system where the hooks extend from the filter layer 200 and hooks onto the loops and fibers in the high loft non-woven layer 100. The projections in one embodiment have a hook shape. The projections 210 may be formed by a textile or extrusion process. These projections have the effect of increasing the lamination force required to remove the filter layer 200 from the high loft non-woven layer 100 and distributing forces through the composite 10 to resist a local buckle or pucker. FIG. 6B illustrates an enlarged view of an embodiment of the composite 10 having a filter layer 200 with projections 210. The projections 210 project into the high loft non-woven layer 100.

In another embodiment, projections 210 may be formed from a slit double needle bar knit fabric. The double needle bar fabric forms two surfaces that are interconnected by stiff mono filament yarns that, when slit along the mid-plane, form two separate fabrics with yarns projecting from one surface at an angle of approximately 45 to 90 degrees to that surface. When this material is pressed onto the high loft non-woven layer 100, the fibers protruding from the slit face penetrate the high loft non-woven layer 100 and entangle with the bulking fibers 110 of the high loft non-woven layer 100. This slit double needlebar fabric may be used alone or in combination with other fabrics to form the filter layer 200 with projections 210.

Layers having projections such as projections 210 may be designed to have the following advantages: 1) When the settable powder sets it will set around the projections creating a strong and durable attachment of the filter layer 200 to the high loft non-woven layer 100. 2) The projections of the filter layer mechanically entangle with the high loft non-woven layer with sufficient strength to retain the settable powder but allow the filter layer to be removed readily after wetting but prior to setting to facilitate the joining of the composite textile with itself or other materials. 3) The projections may extend outwardly from the bottom of the filter layer to help bond the composite 10 to other materials, or provide friction between the composite and an underlying surface.

In one embodiment, the filter layer 200 could be formed to be easily removed (in the unset state) by detaching the projections 210 and reattaching to facilitate bonding between composites 10 or to other surfaces. In one embodiment, the filter layer 200 may be used to facilitate jointing between two sheets for example by extending a flap of the hooked surface to connect between adjacent sheets and form a flush joint or overlapped joint.

In another embodiment, the filter layer 200 could be formed to be easily removed (in the unset state) by detaching the projections 210, to expose the settable powder filled high loft nonwoven layer to allow the settable powder to interact directly with other materials, after hydration but before it is cured. In these cases, it will be appreciated that the filter layer while in place may act to block the settable material from bonding to materials adjacent to it through the action of the settable material's curing process. If a bond is desired between the composite 10 and another material with the filter layer in place, either the additional material must bond to the filter layer, or a separate adhesive must be applied to create a bond between the additional material and the filter layer of composite 10. If the filter layer can be peeled before curing, a bond can be formed between the settable powder and additional materials as the settable powder cures.

For one example, in the case that the settable material 150 is cement based, removing the filter layer 200 may facilitate bonding to a concrete surface and also to allow other material (for example local pebbles or sands) to be able to more easily be incorporated into the surface to improve mechanical performance or blend in to the appearance of the local geology. In a different example, exposing the settable powder filled nonwoven by removing the filter layer may allow joining of multiple sheets laid on top of each other to increase the thickness or incorporate a reinforcing layer (for example steel or glass fiber mesh) between two layers of composite 10 and allow the settable material to readily create a bond between adjacent composites 10.

In a further embodiment, where a layer of sprayed concrete (known to those skilled in the art as Shotcrete or Gunnite), or some other material which forms its strength in situ, has to be applied to increase the thickness of the product, such as when used for hard armor protection, the projections 210 in the filter layer 200 may extend outward from the surface of the filter layer to provide a mechanical keying surface to which the sprayed material can adhere. This has the benefit of providing a better bond to the Shotcrete or Gunnite layer and help prevent adhesion failure. In a still further embodiment, the projections can increase the surface friction of the composite 10 with other materials.

Additional layers may be added to the filter layer before, during, or after the manufacture of the cementitious composite 10 to give the filter layer additional functionality including liquid barrier properties, flame resistance properties, chemical resistance properties, increased tensile and flexural strength, increased stiffness and the like.

In one embodiment, the cementitious composite 10 may contain filter layers 200 on both the first face 100a and the second face 100b of the high loft non-woven layer 100. The filter layers 200 may be directly adjacent the high loft non-woven layer 100 (meaning that no other layers except an adhesion layer may be between the layers 100, 200), or the filter layers 200 and the high loft non-woven layer 100 may have layers between them such as liquid barrier layers 300 or other layers. The projections described above may also be used in the same manner to attach the liquid barrier layer 300 with similar advantages.

Referring back to FIG. 1, there is shown a liquid barrier 300 on the second face 100b of the high loft non-woven layer 100. The liquid barrier layer has a low permeability to water having a coefficient of water permeability of less than about 1×10⁻⁸ m/s. The coefficient of water permeability is also sometimes referred to as the hydraulic conductivity. In another embodiment, the liquid barrier layer has a low permeability to water having a coefficient of water permeability of less than about 1×10⁻¹¹ m/s. The coefficient of water permeability is a measure of the ability of a material to pass fluid, e.g. water, through it. It can be measured using falling head test BS 1377-S 1990 or ASTM D2435-04 or constant head permeability test ASTM D2434-68

The barrier layer 300 is typically used to contain the settable powder 150 in the high loft non-woven layer 100 and form a liquid barrier layer 300. It may also be beneficial as it may aid in keeping excess water around the settable powder 150 during hydration.

In one embodiment, the cementitious composite 10 may contain filter layers 200 on both the first face 100a and the second face 100b of the high loft non-woven layer 100. The filter layers 200 may be directly adjacent the high loft non-woven layer 100 (meaning that no other layers except an adhesion layer may be between the layers 100, 200) or the filter layers 200 and the high loft non-woven layer 100 may have layers between them such as liquid barrier layers 300 or other layers.

The barrier layer 300 may be added to the high loft non-woven layer 100 in any step of the formation of the cementitious composite 10. In one embodiment, the barrier layer 300 is attached to a previously formed high loft non-woven layer 100. The barrier layer 300 may be attached before or after the optional heat and pressure compression. Additionally the heat and pressure compression may be used to fuse the barrier layer 300 to a surface of the high loft non-woven layer 100. In an alternative embodiment, the high loft non-woven layer 100 may be formed on a barrier layer 300.

Preferably, the liquid barrier layer 300 is a film. The liquid barrier layer 300 is attached to the second face 100b of the high loft non-woven layer 100 by any suitable means such as adhesive materials including binder fibers from the high loft non-woven layer 100, additional binder fibers, additional adhesive coatings such as extruded thermoplastic, solution cast coatings or sprayed adhesive, powdered binder, UV curable adhesive, mechanical embedment and/or projections. In one embodiment, the filter layer 300 is attached to the high loft non-woven layer 100 through the binder material 120 in the high loft non-woven layer 100. In one embodiment, the liquid barrier layer is applied as a coating to the second face 100b of the high loft non-woven layer 100 and cured using heat. In another embodiment, an already formed liquid barrier 300 is attached to the second face 100b of the high loft non-woven layer 100.

In one embodiment, the liquid barrier layer 300 is a high density polyethylene (HDPE film) and in another embodiment, the liquid barrier layer is a PVC geomembrane cast onto the second face 100b. Thermal lamination, hot melt extrusion or solution coating can be used to apply the barrier layer 300 onto the high loft non-woven layer 100. The liquid barrier layer 300 can be constructed from various suitable materials. For example, layer 300 can include a polymer such as PVC, HDPE, LLDPE, LDPE, flexible polypropylene fPP, chlorosulphonated polyethylene CSPE-R, polyurethane and/or ethylene propylene diene terpolymer EPDM-R, silicone, latex, natural and other rubbers, Other materials may be used as well. In one embodiment, liquid barrier layer 300 may be about 0.5 mm in thickness. In another embodiment, liquid barrier layer 300 may be PVC and have a thickness of about 9 mm or greater. The liquid barrier layer 300 may also be vapor impermeable. In one embodiment the liquid barrier may consist of two or more layers laminated together, or coextruded, to ensure an extremely low level, 10⁻¹² m/s or less, of liquid permeability. Having two or more layers laminated together may be advantageous to minimize the possibility of random manufacturing defects in any single layer resulting in a leak path and to achieve advantageous properties of two or more different materials.

The liquid barrier layer 300 may also contain reinforcement fibers in the form of loose fibers, a scrim, mesh, or textile. The reinforcement fibers serve to add tensile strength to the liquid barrier layer 300 and the composite 10. The reinforcement fibers may be attached to one or both sides of the liquid barrier layer and be partially or fully embedded into the barrier layer 300. In the embodiments where the reinforcement fibers are attached to one side of the liquid barrier layer 300, they are still considered part of the liquid barrier layer 300.

The reinforcement fibers in or on the barrier layer 300 may be any suitable high tensile strength fibers (or yarns). The specific tensile strength of the reinforcement fibers can be measured using ASTM D2101, In one exemplary embodiment, the specific tensile strength of the reinforcement fibers is in the range of about 7 grams per denier to about 30 grams per denier. In one exemplary embodiment, the specific tensile modulus of the reinforcement fibers is in the range of about 35 gram per denier to about 3500 grams per denier.

The reinforcement fibers used in barrier layer 300 (or any other layer within the cementitious composite 10) may be staple or continuous. Some examples of suitable reinforcement fibers include glass fibers, aramid fibers, and highly oriented polypropylene fibers, basalt fibers and carbon fibers. A non-inclusive listing of suitable fibers for the reinforcement fibers can also include fibers made from highly oriented polymers, such as gel-spun ultrahigh molecular weight polyethylene fibers (e.g., SPECTRA® fibers from Honeywell Advanced Fibers of Morristown, N.J. and DYNEEMA® fibers from DSM High Performance Fibers Co. of the Netherlands), melt-spun polyethylene fibers (e.g., CERTRAN® fibers from Celanese Fibers of Charlotte, N.C.), melt-spun nylon fibers (e.g., high tenacity type nylon 6,6 fibers from Invista of Wichita, Kans.), melt-spun polyester fibers (e.g., high tenacity type polyethylene terephthalate fibers from Invista of Wichita, Kans.), sintered polyethylene fibers (e.g., TENSYLON® fibers from ITS of Charlotte, N.C.), and basalt fibers. Suitable reinforcement fibers also include those made from rigid-rod polymers, such as lyotropic rigid-rod polymers, heterocyclic rigid-rod polymers, and thermotropic liquid-crystalline polymers. Suitable reinforcement fibers made from lyotropic rigid-rod polymers include aramid fibers, such as poly(p-phenyleneterephthalamide) fibers (e.g., KEVLAR® fibers from DuPont of Wilmington, Del. and TWARON® fibers from Teijin of Japan) and fibers made from a 1:1 copolyterephthalamide of 3,4′-diaminodiphenylether and p-phenylenediamine (e.g., TECHNORA® fibers from Teijin of Japan). Suitable reinforcement fibers made from heterocyclic rigid-rod polymers, such as p-phenylene heterocyclics, include poly(p-phenylene-2,6-benzobisoxazole) fibers (PBO fibers) (e.g., ZYLON® fibers from Toyobo of Japan), poly(p-phenylene-2,6-benzobisthiazole) fibers (PBZT fibers), and poly[2,6-diimidazo[4,5-b:4′,5′-e]pyridinylene-1,4-(2,5-dihydroxyl)phenylene] fibers (PIPD fibers) (e.g., M5® fibers from DuPont of Wilmington, Del.). Suitable reinforcement fibers made from thermotropic liquid-crystalline polymers include poly(6-hydroxy-2-napthoic acid-co-4-hydroxybenzoic acid) fibers (e.g., VECTRAN® fibers from Celanese of Charlotte, N.C.). Suitable reinforcement fibers also include boron fibers, silicon carbide fibers, alumina fibers, glass fibers, basalt fibres (e.g. basalt continuous filament made by Basaltex of Wavelgem, Belgium) and carbon fibers, such as those made from the high temperature pyrolysis of rayon, polyacrylonitrile (e.g., OPF® fibers from Dow of Midland, Mich.), and mesomorphic hydrocarbon tar (e.g., THORNEL® fibers from Cytec of Greenville, S.C.). In another exemplary embodiment, the reinforcement fibers may be selected from alkali resistant fibers such as e.g., polyvinyl alcohol (PVA) fibers, polypropylene fibers, polyethylene fibers, etc. In still another exemplary embodiment, reinforcement fibers having an alkali resistant coating may be used such as e.g., PVC coated glass fibers.

In a preferred embodiment, the distance between the outer surfaces of the filter layer 200 and the liquid barrier layer 300 of the flexible cementitious composite 10 (and the resultant rigid or semi-rigid cementitious composite) does not vary by more than 20% in a localized distance when the flexible cementitious composite 10 is curved to a radius of not less than the thickness T.

The localized distance is defined, in this application, to be less than eight times the thickness T of the composite 10 measured on the surface of the filter layer 200. When the variation is greater than 25%, this might form a pucker which could form an area more prone to cracking in the final product due to the reduced thickness. A pucker is an area in which one outer surface locally moves more than 20% towards or away from the other outer surface. A pucker is detrimental because it will change both the density and thickness of the composite material and will result in an area of weakness in the set composite at which a crack is more likely to initiate.

FIGS. 7 and 8 illustrate possible puckering in some composite 10 when the composite 10 is curved to an instantaneous radius R greater than the thickness Z of the composite 10. A pucker forms having a depth D (or height H) of greater than 0.2 times the thickness T of the composite 10. FIG. 7 shows a cross-section external pucker within the filter layer 200 in the composite 10, and FIG. 8 shows an internal pucker in the filter layer 200 in the composite 10. A pucker may also form in the liquid barrier layer 300 when the composite is curved in the opposite direction such that the liquid barrier layer 300 is on the inside (compressive side) of the curve. In another embodiment, the distance between the outer surfaces of the filter layer 200 and the liquid barrier layer 300 of the flexible cementitious composite 10 (and the resultant rigid or semi-rigid cementitious composite) does not vary by more than 15% in a localized distance. In another embodiment, the distance between the outer surfaces of the filter layer 200 and the liquid barrier layer 300 of the flexible cementitious composite 10 (and the resultant rigid or semi-rigid cementitious composite) does not vary by more than 10% in a localized distance.

In one embodiment, there is an in-plane stiffness difference between the liquid barrier layer 300 and the filter layer 200 of at least about 200% in a strain range of between about −20% and +20%. In another embodiment, there is an in-plane stiffness difference between the liquid barrier layer 300 and the filter layer 200 of at least about 500% or more than 1000% in a strain range of between about −20% and +20%. This significant in-plane stiffness difference between the filter layer 200 and the liquid barrier layer 300 allows for one of the layers 200, 300 to more readily stretch or compress in the −20% to 0 and 0 to 20% strain range such that when the composite 10 is curved, one of the layers 200, 300 will stretch more than the other such that the composite is able to conform easily to the substrate on which it is being laid without needing to be forced into position by pinning or using weights and more preferably will deform under its own self weight and that importantly when conforming it will do so without having localized thickness variations such as puckers. It is preferable that the stiffer (in-plane stiffness) of the filter layer 200 and liquid barrier layer 300 (including any reinforcement) will have an in-plane stiffness of at least 7 kN/m in the strain range 0 to 20%, as this will ensure that the complete composite does not stretch excessively during handling or on site placement of the composite, it is also preferable that the least stiff of either the filter layer 200 or the liquid barrier layer 300 will have an in-plane stiffness of less than 7 kN/m and more preferably less than 3 kN/m in the strain range 0 to 20% and preferably also in the strain range 0 to −20% (compression) to prevent the formation of puckers at an instantaneous radius of curvature greater than the thickness of the layer.

Having a knitted fabric as the filter layer 200 may be advantageous due to some knit constructions having low in-plane stiffness at low levels of strain (because the fibers can change orientation for small strains until they are aligned with the direction of the strain or constrained by the knots). This alignment typically occurs in a strain range of −20 to +20%, which can help to prevent puckers forming because the knitted surface can stretch or compress when the material is curved.

In-plane stiffness of a layer (200 or 300) as used herein shall be defined as the mean stiffness (Young's Modulus E) of the Young's Modulus E measured in two orthogonal directions in the plane of the layer (representing the machine direction of the product and the cross machine direction, e.g., X and Y direction in FIG. 1 (Y direction not shown in the figure, but is perpendicular to both the X and Z axis) multiplied by the thickness of the layer T. It will be recognized by someone skilled in the art that for most practical purposes it is only possible to measure a textile's stiffness in the tensile (positive) range. By way of example, the in-plane stiffness of a filter layer is measured using the following process. A filter layer 200 is placed in a tensometer, the slack is taken up out of the filter layer by stretching the filter layer until there is no visible slack typically a small positive force of under 5 N is applied across the specimen. The Unloaded Length is then measured. The filter layer specimen is then stretched to obtain a target strain of 20%, where Strain (ε) is calculated using the equation:

ε=e/L₀

e=Extension, and L₀=Unloaded Length. A force extension graph is plotted and the Young's Modulus (E) is calculated using the formula

E=(FL₀)A₀e

where F is the force applied in tension to the specimen at a given elongation, A₀ is the original cross-sectional area of the specimen through which the force is applied, and e and L₀ are defined above. The slope of the Force Extension graph at the midpoint of the range gives F/e, which can be used to calculate the Young's Modulus for the filter layer in the direction that the test was carried out. Specifically, F/e can be calculated by drawing a tangent to the Force versus extension curve as the midpoint of the strain range, in this case at 10% strain, and measuring the slope of the tangent line. It will be appreciated by one skilled in the art that certain materials used to form layers 200 or 300 may not extend to a target strain of 20% without breaking. In those cases where the sample cannot be extended to a 20% strain, the Young's modulus is measured at the midpoint of zero strain and the maximum strain at which the product either fails or yields in tension. It will further be appreciated by one skilled in the art that measurement of the plane stiffness when compressing (−20% to 0% strain) an individual layer can be difficult because it does not have the same mechanical constraints on it when it is isolated. Therefore, within the body of this document, the strain range is discussed as either −20% to 20%, −20% to 0%, or 0% to 20%, based on practicality of measurement of in-plane stiffness in the compressive range.

In an example, one specific filter layer has a Young's Modulus of 5.36 MPa measured in the X direction and 5.16 MPa measured in the Y direction between 0 and 20% tensile strain, therefore the mean Young's Modulus is 5.26 MPa. The filter layer 200 has a mean thickness (in the Z direction) of 2.2 mm. Therefore, for this filter layer 200, the in-plane stiffness is calculated to be 11.6 kN/m.

When liquid (preferably water) is added to the flexible composite 10, the settable powder is hydrated and cures to form a rigid or semi-rigid composite. Liquid may be added to the flexible composite 10 before the composite 10 is placed in an application or after the composite is installed. For example, the flexible composite 10 comprises a cementitious settable powder. It is placed in a culvert and then saturated with water to cure and form the rigid (or semi rigid) cementitious composite.

The flexibility of the composite allows it to conform to the surfaces it is in contact with. The surface geometry of the flexible composite may be very complex as it is installed, contrasting with a cementitious sheet such as a cementitious backer-board or rigid panel or building product. These cementitious sheet products are manufactured to have a very regular geometry, as dictated by a continuous manufacturing/curing line. Whereas the flexible composite described hydrates and cures in use while contacting the immediate surface on which it is installed, it may therefore be a rigid or semi-rigid cementitious sheet which deviates substantially from a planar geometry in a non-uniform way across the product. In fact, it may exhibit curvatures with two or more non parallel axes. This deviation may substantially allow the hardened product to conform to the specific surface it is in contact with reducing the loads on the sheet in use and therefore improving the durability of the sheet.

In one embodiment, the flexible composite 10 is equipped with a flap to facilitate joining one composite 10 to another composite 10. A flap can be created through several different techniques. For example, bulking fibers 110 and/or reinforcement fibers along one of the faces 100a and 100b of high loft non-woven layer 100 could be trimmed or cut to create a flap. In still another embodiment, second face 100b could be formed with high tensile strength yarns that extend along second face 100b of the high loft non-woven layer 100 to form a flap, in another embodiment the flap may have hooked projections such as 210 to facilitate joining it to the filter layer 200 or the high loft non-woven layer 100 of an adjacent sheet of the flexible cementitious composite 10. In each of the above described configurations, the flap can still be integral with the cementitious composite 10. However, the flap can also be a separate element that is added to cementitious composite 10 by e.g., mechanical means such as stitching or using adhesives.

### EXAMPLES

### Example 1

A high loft non-woven layer 100 was produced by air laying a fiber blend of bulking fibers and binder fibers using a STRUTO™ vertically lapped non-woven machine, as described herein. In particular, the non-woven was produced from a fiber blend containing approximately 20 weight % (based on the total weight of the fiber blend) of 15 denier low-melt thermoplastic polyester (PET) binder fibers, 40 weight % of high-crimp PET bulking fibers, which had a linear density of 100 denier and 40 weight % of high-crimp PET bulking fibers, which had a linear density of 200 denier. The above-described fiber blend was opened and carded into a web. The carded web is conveyed up an incline apron and was fed into the STRUTO Lapping device. The Vertical Lapper then folded the web into a uniform structure. The folds were compressed together into a continuous structure. The structure was held in a vertical position as it entered the heated thermal bonding oven in which air, heated to a temperature of approximately 175° C. (347° F.) was used to partially melt the binder fibers in the core material. Once the structure had been thermally bonded, it entered a cooling zone causing the bonded structure to become permanent. The high loft non-woven layer had a basis weight of approximately 300 g/m² and was 19 mm thick.

A 170 g/m² PET needle-punched filter layer was attached to the high loft non-woven layer on a first surface using a needling process to mechanically interlock the fibers in the filter layer with the high loft non-woven layer. The filter layer had a thickness of 2.23 mm, a Young's Modulus of 5.3 MPa, and an in plane stiffness of 11.7 kN/m (averaged over 0 to 20% strain in 2 perpendicular directions). An alumina rich cement was metered onto the second surface of high loft non-woven (opposite the first surface); the second surface was then exposed to a vibrating bed to allow the alumina rich cement to disperse into the high loft non-woven layer, assisted by a brush that scraped the top surface periodically.

A 0.15 mm (6 mils) thick polyethylene film with a basis weight of 100 g/m² was laminated to the second surface high of a loft high loft non-woven layer (after the high loft non-woven layer was filled) using a platen press to form a liquid barrier layer. The polyethylene film had a Young's Modulus of 242 MPa and an in-plane stiffness of 36.9 kN/m (averaged over 0-10% strain in 2 perpendicular directions). The lamination process was carried out at a pressure of approximately 0.41 MPa (60 psi) and a temperature of approximately 190° C. The samples were exposed to this heat and pressure for about 2-5 minutes, and then allowed to cool back to room temperature while under the same pressure, using a water and air cooled platen. The lamination process set the final thickness and packing density of the cement filled composite. The thickness of the flexible composite 10 was approximately 10 mm thick with a density of 1.55 g/cc. The fiber to cement ratio in the filled high loft non-woven layer was 2% by weight.

To cure the specimen, it was saturated with approximately 20° C. water for about 10 minutes, and then placed between stainless steel sheets in an approximately 20° C. water bath where it remained completely submerged for about a day. The stainless steel sheets were used to ensure that the specimen cured in a flat configuration. After the sample was removed from the water bath, it was cut using a rotary saw into specimens for testing.

The density of the cured, rigid composite was 2.1 g/cc. The flexural properties of the cured product were measured using a three-point bend test of ASTM C1185. Flexural strength was calculated at the first crack (first stress maxima) of about 9.6 MPa (1400 psi).

### Example 2

The flexible composite of Example 2 was formed from the same materials and processes of Example 1, except that the amount of high alumina cement metered onto the top surface of the high loft non-woven was less so that the equivalent lamination process resulted in the thickness of the flexible composite being reduced to approximately 6 mm thick with a density of 1.5 g/cc. The fiber to cement ratio in the filled high loft non-woven layer was 3.4% by weight.

To cure the specimen, it was saturated with approximately 20° C. water for about 10 minutes, and then placed between stainless steel sheets in an approximately 20° C. water bath where it remained completely submerged for about a day. The stainless steel sheets were used to ensure that the specimen cured in a flat configuration. After the sample was removed from the water bath, it was cut using a rotary saw into specimens for testing.

The cured product density was 2.04 g/cc. The cured composite had a flexural strength calculated at the first crack (as described in example 1) of 7.6 MPa (1100 psi).

### Example 3

The high loft non-woven layer of Example 3 was created as described in Example 1.

A 170 g/m² PET needle-punched filter layer was attached to the first surface of the non-woven layer using a needling process to mechanically interlock the fibers in the filter layer with the high loft non-woven layer. The filter layer had a thickness of 2.23 mm, a Young's Modulus of 5.3 MPa, and an in-plane stiffness of 11.7 kN/m (averaged over 0 to 20% strain in 2 perpendicular directions). A larger mass of alumina rich cement than used in examples 1 and 2 was metered onto the second surface of high loft non-woven and the second surface was then exposed to a vibrating bed to allow the alumina rich cement to disperse into the high loft non-woven layer, assisted by a brush that scraped the top surface periodically.

A coating knife was used to apply a continuous coat of a polyvinyl chloride (PVC) plastisol (Marchem Southeast V1337) with a thickness of 2.8 mm onto the second surface of the high loft non-woven layer. The coating was heat cured with a hot air gun without applying pressure to the composite. The thickness of the resultant filled flexible composite was approximately 22 mm thick with a density of 1.3 g/cc. The fiber to cement ratio in the filled high loft non-woven layer was 1.2% by weight.

To cure the specimen, it was saturated with approximately 20° C. water for about 10 minutes, and then placed between stainless steel sheets in an approximately 20° C. water bath where it remained completely submerged for about a day. The stainless steel sheets were used to ensure that the specimen cured in a flat configuration. After the sample was removed from the water bath, it was cut using a rotary saw into specimens for testing.

The cured product density was 2.14 g/cc. The cured composite had a flexural strength calculated at the first crack (as described in example 1) of 3.24 MPa (470 psi).

### Example 4

A high loft non-woven layer 100 was produced by air laying a fiber blend using a K-12 HIGH LOFT RANDOM CARD by Fehrer AG (Linz, Austria). In particular, the high loft non-woven layer was produced from a fiber blend containing approximately 60 weight % (based on the total weight of the fiber blend) of 15 denier low-melt thermoplastic PET binder fibers and approximately 40 weight % of high-crimp PET bulking fibers, which had a linear density of 45 denier. The above described fiber blend was air-laid onto a moving belt. Following the air laying step, the resulting composites were passed through a through-air pre-heat oven in which air, heated to a temperature of approximately 175° C. (347° F.) was used to partially melt the binder fibers in the core material. The non-woven had a basis weight of approximately 300 g/m².

A 50 g/m² PET spunbond filter layer was attached to the first surface of the non-woven layer using a spray adhesive (3M Quick Drying Tacky Glue). The filter layer had a thickness of about 0.25 mm, a Young's Modulus of 28.8 MPa, and an in-plane stiffness of 7.2 kN/m (averaged over 0 to 20% strain in 2 perpendicular directions). An alumina rich cement was metered onto the second surface of the high loft non-woven which was then exposed to a vibrating bed to allow the alumina rich cement to disperse into the high loft non-woven layer, assisted by a brush that scraped the top surface periodically.

A coating knife was used to apply a continuous coat of a PVC plastisol manufactured by Speciality Coatings Ltd. of Darwen UK with a thickness of about 1.5 mm to the second surface of the high loft non-woven layer. The coating was heat cured with a hot air gun without applying pressure to the composite. The thickness of the finished filled-cloth composite was approximately 17 mm thick and had a density of 1.1 g/cc. The fiber to cement ratio in the filled high loft non-woven layer was 1.8% by weight.

To cure the specimen, it was saturated with approximately 20° C. water for about 10 minutes, and then placed between stainless steel sheets in an approximately 20° C. water bath where it remained completely submerged for about a day. The stainless steel sheets were used to ensure that the specimen cured in a flat configuration. After the sample was removed from the water bath, it was cut using a rotary saw into specimens for testing. The specimens were typically left submerged in water for about a day before being removed for testing.

The cured product density was 1.8 g/cc. The cured composite had a flexural strength calculated at the first crack (as described in example 1) of 2.09 MPa (303 psi).

### Example 5

A high loft non-woven layer 100 was produced as in Example 4, A 175 g/m² Stabilon™ composite scrim containing a 30 g/m² glass mat with high tensile G37 glass yarn reinforcements was attached to the first surface of the high loft non-woven layer using hot melt gravure lamination. The filter layer had a thickness of 0.64 mm, a Young's Modulus of 1.26 GPa, and an in-plane stiffness of 800 kN/m (averaged over 0 to 3.5% strain in 2 perpendicular directions). An alumina rich cement was metered onto the second surface of the high loft non-woven which was then exposed to a vibrating bed to allow the alumina rich cement to disperse into the high loft non-woven layer, assisted by a brush that scraped the top surface periodically.

A 0.15 mm (6 mil) thick polyethylene film with a basis weight of 100 g/m² was laminated to the second surface of the high loft non-woven layer (on the side opposite the scrim) using a platen press to form a liquid barrier layer. The polyethylene film had a Young's Modulus of 242 MPa, and an in-plane stiffness of 36.9 kN/m (averaged over 0 to 10% strain in 2 perpendicular directions). The lamination process was carried out at a pressure of approximately 0.41 MPa (60 psi) and a temperature of around 190° C. The samples were exposed to heat and pressure for about 2-5 minutes, and then allowed to cool back to room temperature under pressure using a water and air cooled platen. The lamination process was also used to set the final thickness and packing density of the cement filled composite. The thickness of the finished filled-cloth composite was approximately 10 mm thick and had a density of about 1.5 g/cc. The fiber to cement ratio in the filled high loft non-woven layer was 2% by weight.

To cure the specimen, it was saturated with approximately 20° C. water for about 10 minutes, and then placed between stainless steel sheets in an approximately 20° C. water bath where it remained completely submerged for about a day. The stainless steel sheets were used to ensure that the specimen cured in a flat configuration. After the sample was removed from the water bath, it was cut using a rotary saw into specimens for testing. The specimens were typically left submerged in water for about a day before being removed for testing.

The cured product density was 2.06 Wm. The cured composite had a flexural strength calculated at the first crack (as described in example 1) of 8.41 MPa (1220 psi).

### Example 9

A high loft non-woven layer was produced as described in Example 1. A 170 g/m² PET needle-punched filter layer was attached to the first surface of the high loft non-woven layer using a needling process to mechanically interlock the fibers in the filter layer with the high loft non-woven layer. The filter layer had a thickness of 2.23 mm, a Young's Modulus of 5.26 MPa, and an in-plane stiffness of 11.74 kN/m (averaged over 0 to 20% strain in 2 perpendicular directions). The filter layer in-plane stiffness was therefore greater than 7 kN/m.

An alumina rich cement was metered onto the second surface of the high loft non-woven which was then exposed to a vibrating bed to allow the alumina rich cement to disperse into the high loft non-woven layer, assisted by a brush that scraped the top surface periodically. A PVC layer (Marchem Southeast V1337) was cast onto the second surface forming a liquid barrier layer. The PVC layer had a thickness of 0.55 mm, a Young's Modulus of 18.7 MPa, and an in-plane stiffness of 10.3 kN/m (averaged over 0 to 20% strain in 2 perpendicular directions). The PVC layer in-plane stiffness was therefore also greater than 7 kN/m.

The filter layer and the liquid barrier layer in-plane stiffness were within 15% of each other. The thickness of the filled cloth was approximately 18 mm and the thickness was relatively consistent across the flexible composite when flat.

The sample was bent around a steel bar with a diameter of 30 mm with the filter layer being the outermost surface (furthest from the steel bar) and the PVC innermost, it was observed that the thickness of the curved sample varied substantially decreasing from 18 mm to approximately 10 mm to 12 mm in places. This thickness decrease corresponded to the radius of curvature and was non-uniform, the same sample when curved similarly to a radius of 50 mm showed a thickness variation of between 18 mm and 14 mm.

The sample was then bent around the same steel bar with the filter layer now being the innermost surface and the PVC layer outermost. It was observed that the thickness reduced by approximately 1 mm and puckers formed on surface of the inside non-woven filter layer, reducing the thickness from 18 mm to 13 mm at the apex of the puckers.

In this example, the composite was curved in both directions to a radius approximately equal to the thickness of the composite resulting in a localized thickness variation of greater than 20% in both directions of curvature. If the material had been allowed to cure in this curved state, these thickness variations might result in weak areas where cracks would be more likely to initiate. The filter layer and liquid barrier layer in the composite had similar in-plane stiffness values. Also, neither layer had an in-plane stiffness less than 7 kN/m (which would have helped the composite curve without puckering or significant localized thickness variation).

### Example 10

A high loft non-woven layer was produced as described in Example 1. A 170 g/m² PET needle-punched filter layer was attached to the first surface of the high loft non-woven layer using a needling process to mechanically interlock the fibers in the filter layer with the high loft non-woven layer. The filter layer had a thickness of 2.23 mm, a Young's Modulus of 5.26 MPa, and an in-plane stiffness of 11.7 kN/m (averaged over 0 to 20% strain) (significantly greater than 7 kN/m).

An alumina rich cement was metered onto the second surface of the high loft non-woven which was then exposed to a vibrating bed to allow the alumina rich cement to disperse into the high loft non-woven layer, assisted by a brush that scraped the top surface periodically. A knitted, coated stretch fabric formed from latex (spandex) and polyester fibers was laminated to the second surface of the high loft non-woven layer to form the liquid barrier layer as follows: a RS Heavy Duty Adhesive (available from RS Ltd. in the UK) was applied to both the stretch fabric and the filled high loft non-woven layer and then the two layers were compressed together between platens at a pressure of 2.5 MPa. The top platen, which was in contact with the stretch fabric, was maintained at a constant temperature of approximately 120° C. for 5 minutes and then water cooled to approximately 27 CC over a further 5 minute period, while the pressure was maintained. The knitted liquid barrier layer 300 had a thickness of 0.33 mm, a Young's Modulus of 2.73 MPa, and an in-plane stiffness of 0.90 kN/m (averaged over 0 to 20% strain in two perpendicular directions) (in-plane stiffness was below 3 kN/m). The thickness of the flexible composite was approximately 13 mm.

The non-woven filter layer was significantly stiffer than the stretch fabric layer (having an in-plane stiffness 1200% greater than the liquid barrier layer) with the formed composite having a large difference between the in-plane stiffness values of the filter layer and the liquid barrier layer (one layer with a stiffness that was significantly above 7 kN/m and the another layer with a stiffness that was below 3 kN/m).

The flexible composite was bent around a steel bar with a diameter of 30 mm with the first surface (non-woven filter layer) forming the outermost surface. It was observed that the thickness remained approximately constant at 13 mm in the curved state and no visible puckers formed on the second surface of the high loft non-woven layer (the liquid barrier layer). The flexible composite was then bent around the same steel bar in the opposite direction with the first surface (non-woven filter layer) now on the inside. It was observed that while the thickness reduced by approximately 1 mm this was approximately uniform and no puckers (or localized thickness variations of greater than 10%) were visible on the inside non-woven filter face 200. Therefore, this composite would be less likely to have weak areas due to changes in thickness if it had been allowed to set in this curved position.

As the density of the unhydrated product increases, the flexural strength increases. Comparison of examples 1-3, all made with the same base non-woven substrate, demonstrate the effect of product density on final composite performance. Example 3 which was not exposed to any pressure to increase the product density demonstrated the lowest product flexural strength. With increasing density from 1.3 to 1.55 g/cm³, the flexural strength at first crack more than doubles.

This same behavior can also be seen by comparing Examples 3 and 5, which use the K12 highloft non-woven. The density of the final product is increased from about 1.1 g/cm³ to 1.5 g/cm³ by compressing the non-woven. The resulting flexural strength at first crack increases from about 2.07 MPa (300 psi) to over 8.27 MPa (1200 psi).

The highest density specimens were obtained by applying heat and pressure together to densify the product and then cool it under pressure. This general process therefore provides flexible composites with the highest density and flexural strength, regardless of thickness.

The composites made with Struto high loft and K12 high loft were all filled with cement using the same process but each of them attained a different density after the same time based on how tortuous the paths are for the cement to sift through. The selection of specific fiber deniers and combinations, as well as the orientation, affects this ease of filling. The subsequent compression under heat and cooling under pressure to set the thickness allows a final product with a higher density to be consistently obtained.

The mechanically bonded filter layer with projections of examples 1-3 were compared with the adhesively laminated filter layer of examples 4-5. The mechanically bonded filter layers were robust, and difficult to remove, whereas the adhesively laminated filter layers were easier to remove.

In Example 9, the difference in the in-plane stiffness was less than 15% between the filter layer and the liquid barrier layer. Both the filter layer and the liquid barrier layer had in-plane stiffness significantly above 7 kN/m. This combination of physical features contribute to the formation of puckers and other non-uniform changes in thickness of the specimen when it is curved. These areas where puckers form would be weaker in the composite after it is set to become rigid or semi-rigid, and would likely initiate cracks in the composite in use. The high in-plane stiffness of both the filter and liquid barrier layers also reduces the ability of the specimen to readily conform when placed on uneven ground.

In Example 10 the difference in the in-plane stiffness was 1200% between the filter layer 200 and the liquid barrier layer 300. For this composite, there was very little change in thickness with no puckering when the material was curved to a radius that was approximately the same as its own thickness. The stiffer filter layer had an in-plane stiffness significantly above 7 kN/m which prevents excessive strain during installation and the stretch liquid barrier layer 300 had an in-plane stiffness significantly below 3 kN/m which minimized the formation of puckers and other non-uniform changes in thickness when the sample was curved. This combination of physical properties also allowed the sample to readily conform. It is expected that a composite would work equally well if the barrier layer had been the stiffer layer and filter layer the low in-plane stiffness stretch layer.

These examples demonstrate the ability to form a textile composite which is capable of becoming rigid or semi-rigid based on a high loft non-woven based on discontinuous fibers. The current invention, though based on a textile with an irregular, tortuous volume, after exposure to a liquid (water) to cure the settable powder (cement), has flexural properties equivalent to materials made with more regular volumes and continuous fibers.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A flexible cementitious composite capable of becoming rigid or semi-rigid, comprising:
a high loft non-woven layer having a first face and a second face, the second face separated from the first face by a space, wherein the high loft non-woven layer comprises bulking fibers and a binding material, wherein at least a portion of the bulking fibers are connected to other bulking fibers within the high loft non-woven layer through the binding material, wherein a midpoint between the first face and the second face of the high loft non-woven layer defines a midpoint plane, wherein at least about 50% by number of bulking fibers crossing the midpoint plane form a tangential line at the midpoint plane of between about 45 degrees and 90 degrees;
a settable powder located in the high loft non-woven layer, wherein the settable powder is capable of setting to a rigid or semi-rigid solid on the addition of a liquid;
a filter layer on the first face of the high loft non-woven layer, wherein the filter layer comprises projections which project at least partially into the high loft non-woven layer, and wherein the filter layer comprises pores that are sufficiently small as to retain at least a portion of the settable powder within the high loft non-woven layer but allow the passage of the liquid; and,
a liquid barrier layer on the second face of the high loft non-woven layer, wherein the liquid barrier layer has a coefficient of water permeability of less than about 1×10⁻⁸ m/s.

2. The flexible cementitious composite of claim 1, wherein at least about 70% by number of bulking fibers crossing the midpoint plane form a tangential line at the midpoint plane of between about 70 degrees and 90 degrees.

3. The flexible cementitious composite of claim 1, wherein the projections project at least 0.4 mm into the high loft non-woven layer.

4. The flexible cementitious composite of claim 1, wherein the projections project into the high loft non-woven layer at least 5% of the distance between the first face and the second face of the high loft non-woven layer.

3. The flexible cementitious composite of claim 1, wherein the high loft non-woven is stratified, wherein the first face of the high loft non-woven layer comprises a higher concentration of binding material than bulking fibers, and wherein the binding material is melted bonded together to form an integral filter layer.

6. The flexible cementitious composite of claim 1, wherein the liquid barrier layer is attached to the second face of the high loft non-woven layer through the binder material of the high loft non-woven layer.

7. The flexible cementitious composite of claim 1, wherein the high loft non-woven comprises serpentine-like arrangement of a multiplicity of pleats in which adjoining pleats physically contact each other thereby causing the structure to be self-supporting, and wherein the pleats are generally parallel to adjacent pleats.

8. The flexible cementitious composite of claim 1, wherein within the strain range of −20% to 20%, −20% to 0%, or 0% to 20%, the liquid barrier layer and the filter layer have a difference in in-plane stiffness of at least about 200%.

9. The flexible cementitious composite of claim 1, wherein within the strain range of 0 to 20% the liquid barrier layer has an in-plane stiffness of at least about 7 kN/m and within the strain range of −20% to 20%, −20% to 0%, or 0% to 20% the filter layer has an in-plane stiffness of less than 7 kN/m.

10. The flexible cementitious composite of claim 1, wherein within the strain range of 0% to 20% the filter layer has an in-plane stiffness of at least about 7 kN/m and within the strain range of −20% to 20%, −20% to 0%, or 0% to 20% the liquid barrier layer has an in-plane stiffness of less than 7 kN/m.

11. The flexible cementitious composite of claim 1, wherein the distance between the first face and second face does not vary by more than 20% in a localized distance across the high loft non-woven layer when the high loft non-woven layer is in a flat state or has a radius of curvature of not less than the thickness of the non-woven layer.

12. The flexible cementitious composite of claim 1, wherein the filter layer comprises a slit double needle bar knit fabric.

13. The flexible cementitious composite of claim 1, wherein the projections of the filter layer comprise a hook shape.

14. The flexible cementitious composite of claim 1, wherein the distance between the first face and second face does not vary by more than 20% in a localized distance across the high loft non-woven layer when the high loft non-woven layer is in a flat state or has a radius of curvature of not less than the thickness of the high loft non-woven layer.

15. A rigid or semi-rigid cementitious composite comprising:
a high loft non-woven layer having a first face and a second face, the second face separated from the first face by a space, wherein the high loft non-woven layer comprises bulking fibers and a binding material, wherein at least a portion of the bulking fibers are connected to other bulking fibers within the high loft non-woven layer through the binding material, wherein a midpoint between the first face and the second face of the high loft non-woven layer defines a midpoint plane, wherein at least about 50% by number of bulking fibers crossing the midpoint plane form a tangential line at the midpoint plane of between about 45 degrees and 90 degrees;
a cured rigid or semi-rigid solid located in the high loft non-woven;
a filter layer on the first face of the high loft non-woven layer, wherein the filter layer comprises projections which project at least partially into the high loft non-woven layer, and wherein the filter layer comprises pores that are sufficiently small as to retain at least a portion of the settable powder within the high loft non-woven layer but allow the passage of the liquid; and,
a liquid barrier layer on the second face of the high loft non-woven layer, wherein the liquid barrier layer has a coefficient of water permeability of less than about 1×10⁻⁸ m/s.

16. The rigid or semi-rigid cementitious composite of claim 15, wherein at least about 70% by number of bulking fibers crossing the midpoint plane form a tangential line at the midpoint plane of between about 70 degrees and 90 degrees.

17. The rigid or semi-rigid cementitious composite of claim 15, wherein the projections project at least 0.4 mm into the high loft non-woven layer.

18. The rigid or semi-rigid cementitious composite of claim 15, wherein the projections project into the high loft non-woven layer at least 5% of the distance between the first face and the second face of the high loft non-woven layer.

19. The rigid or semi-rigid cementitious composite of claim 15, wherein the high loft non-woven is stratified, wherein the first face of the high loft non-woven layer comprises a higher concentration of binding material than bulking fibers, and wherein the binding material is melted bonded together to form an integral filter layer.

20. The rigid or semi-rigid cementitious composite of claim 15, wherein the high loft non-woven comprises serpentine-like arrangement of a multiplicity of pleats in which adjoining pleats physically contact each other thereby causing the structure to be self-supporting, and wherein the pleats are generally parallel to adjacent pleats.

21. The rigid or semi-rigid cementitious composite of claim 15, wherein within the strain range of −20% to 20% or −20% to 0% or 0% to 20%, the liquid barrier layer and the filter layer have a difference in in-plane stiffness of at least about 200%.

22. The rigid or semi-rigid cementitious composite of claim 15, wherein within the strain range of 0 to 20% the liquid barrier layer has an in-plane stiffness of at least about 7 kN/m and within the strain range of −20% to 20% or −20% to 0% or 0% to 20% the filter layer has an in-plane stiffness of less than 7 kN/m.

23. The rigid or semi-rigid cementitious composite of claim 15, wherein within the strain range of 0% to 20% the filter layer has an in-plane stiffness of at least about 7 kN/m and within the strain range of −20% to 20% or −20% to 0% or 0% to 20% the liquid barrier layer has an in-plane stiffness of less than 7 kN/m.

24. The rigid or semi-rigid cementitious composite of claim 15, wherein the distance between the first face and second face does not vary by more than 20% in a localized distance across the high loft non-woven layer when the high loft non-woven layer is in a flat state or has a radius of curvature of not less than the thickness of the non-woven layer.

25. The rigid or semi-rigid cementitious composite of claim 15, wherein the filter layer comprises a slit double needle bar knit fabric.

26. The rigid or semi-rigid cementitious composite of claim 15, wherein the projections of the filter layer comprise a hook shape.

27. The rigid or semi-rigid cementitious composite of claim 15, wherein the composite deviates from a planar geometry in a non-uniform way across the product exhibiting curvatures with two or more non-parallel axes.

28. The rigid or semi-rigid cementitious composite of claim 15, wherein the distance between the first face and second face does not vary by more than 20% in a localized distance across the high loft non-woven layer when the high loft non-woven layer is in a flat state or has a radius of curvature of not less than the thickness of the high loft non-woven layer.
